(19) United States
(12) Patent Application Publication
(10) Pub. No.: US 2024/0103773 A1
(43) Pub. Date: Mar. 28, 2024

(54) PORTABLE TERMINAL APPARATUS, PRINTING SERVICE SYSTEM, NON-TRANSITORY COMPUTER READABLE MEDIUM STORING PROGRAM, AND METHOD

(71) Applicant: FUJIFILM Business Innovation Corp., Tokyo (JP)

(72) Inventor: Yuji OHASHI, Kanagawa (JP)

(73) Assignee: FUJIFILM Business Innovation Corp., Tokyo (JP)

(21) Appl. No.: 18/165,909

(22) Filed: Feb. 7, 2023

(30) Foreign Application Priority Data
Sep. 26, 2022 (JP) 2022-152290

(51) Int. Cl. G06F 3/12; H04W 4/029

(52) U.S. Cl. CPC G06F 3/1204; G06F 3/1238; G06F 3/1292; H04W 4/029

(57) ABSTRACT

A portable terminal apparatus includes a processor configured to estimate a movement direction of a user carrying the portable terminal apparatus from a transition of a current position, from among image forming apparatuses capable of printing a document file to be printed, predict an image forming apparatus to be used for printing the document file by the user, by referring to the movement direction of the user, and provide a printing start instruction of the document file from the image forming apparatus in a case where the user has approached the image forming apparatus to a distance in which printing is estimated to be finished at a point when the user arrives at an installation position of the image forming apparatus.

### CROSS-REFERENCE TO RELATED APPLICATIONS

This application is based on and claims priority under 35 USC 119 from Japanese Patent Application No. 2022-152290 filed Sep. 26, 2022.

### BACKGROUND

### (i) Technical Field

The present invention relates to a portable terminal apparatus, a printing service system, a non-transitory computer readable medium storing a program, and a method.

### (ii) Related Art

Currently, cashierless unmanned stores that enable shopping without payment in a real store are present. Since payment is not necessary, a user can simply leave the store in a case where shopping is finished. That is, “waiting” such as lining up at a checkout does not occur.

In recent years, a printing service called net print through a network has been provided. In the printing service, the user can execute printing to obtain a printed matter by uploading a document to be printed in advance and inputting a reservation number issued in the uploading into a multifunction peripheral installed in a store such as an intended convenience store.

In a case where application of the printing service to the above cashierless unmanned stores is considered, going to the store and performing a user operation with respect to the multifunction peripheral are necessary. Thus, “waiting” may occur until the printed matter is output.

Therefore, in the related art, a technology for calculating, in advance, a required time required for printing, calculating a movement time required until a user arrives at an installation position of a multifunction peripheral, at a predetermined time interval based on wireless communication between the multifunction peripheral and a portable terminal carried by the user, and starting execution of the printing at a point when the movement time is less than or equal to the required time has been suggested so that “waiting” does not occur until the output of the printed matter is finished (for example, JP2013-162313A).

### SUMMARY

In the related art, a user designates an image forming apparatus to be used for printing and outputs a printing instruction to the image forming apparatus in advance.

Aspects of non-limiting embodiments of the present disclosure relate to a portable terminal apparatus, a printing service system, a non-transitory computer readable medium storing a program, and a method that enable printing without causing a user to output a printing start instruction for a document file to be printed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a portable terminal apparatus including a processor configured to estimate a movement direction of a user carrying the portable terminal apparatus from a transition of a current position, from among image forming apparatuses capable of printing a document file to be printed, predict an image forming apparatus to be used for printing the document file by the user, by referring to the movement direction of the user, and provide a printing start instruction of the document file from the image forming apparatus in a case where the user has approached the image forming apparatus to a distance in which printing is estimated to be finished at a point when the user arrives at an installation position of the image forming apparatus.

### BRIEF DESCRIPTION OF THE DRAWINGS

Exemplary embodiment(s) of the present invention will be described in detail based on the following figures, wherein:

FIG. 1 is an overall configuration diagram of a printing service system in the present exemplary embodiment;

FIG. 2 is a hardware configuration diagram of a portable terminal apparatus in the present exemplary embodiment;

FIG. 3 is a hardware configuration diagram of a multifunction peripheral in the present exemplary embodiment;

FIG. 4 is a block configuration diagram illustrating the printing service system in the present exemplary embodiment;

FIG. 5 is a diagram illustrating an example of a data configuration of store-related information in the present exemplary embodiment;

FIG. 6 is a sequence diagram illustrating processing until a user registers printing to obtain a printed matter in the present exemplary embodiment;

FIG. 7 is a diagram illustrating a display example of a document registration screen in the present exemplary embodiment;

FIG. 8A is a flowchart illustrating printing control processing in the present exemplary embodiment;

FIG. 8B is a flowchart continued from FIG. 8A;

FIG. 9 is a diagram illustrating a display example of a printing start notification screen in the present exemplary embodiment;

FIG. 10 is a diagram illustrating a display example of a setting change screen in the present exemplary embodiment;

FIG. 11 is a diagram illustrating a display example of an inquiry screen in the present exemplary embodiment;

FIG. 12 is a flowchart illustrating printing processing executed by the multifunction peripheral in the present exemplary embodiment;

FIG. 13 is a diagram illustrating a display example of an alert screen in the present exemplary embodiment;

FIG. 14 is a diagram illustrating a display example of an operation panel of the multifunction peripheral in the present exemplary embodiment; and

FIG. 15 is a diagram illustrating a display example of a user addition screen in the present exemplary embodiment.

### DETAILED DESCRIPTION

Hereinafter, an exemplary embodiment of the present invention will be described based on the drawings.

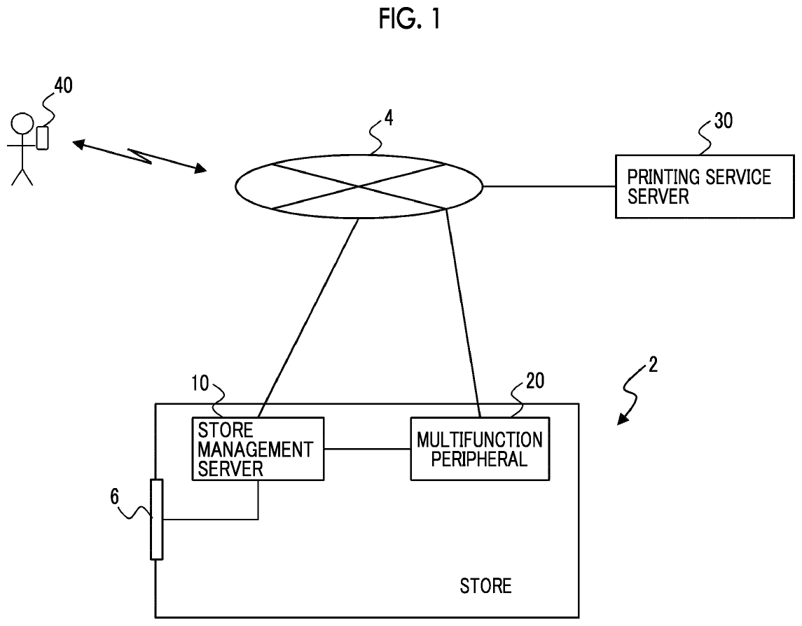

FIG. 1 is an overall configuration diagram of a printing service system in the present exemplary embodiment. In FIG. 1, a configuration in which a store management server 10 and a multifunction peripheral 20 installed in a store 2, a printing service server 30 that provides a printing service to a user, and a portable terminal apparatus 40 carried by the user are connected in a wired or wireless manner via a network 4 such as the Internet is illustrated.

The store 2 is used by a visitor, that is, the user carrying the portable terminal apparatus 40 in the present exemplary embodiment. The user enters the store from an entrance 6 of the store 2, uses the multifunction peripheral 20, or purchases a product and then, leaves the store from the entrance 6. A wireless communication apparatus (not illustrated) to which the user holds the portable terminal apparatus 40 to wirelessly connect the portable terminal apparatus 40 using the near field communication (NFC) standard is arranged in the entrance 6. The wireless communication apparatus is connected to the store management server 10 and transmits information scanned from the wirelessly connected portable terminal apparatus 40 to the store management server 10. The store 2 in the present exemplary embodiment is assumed to be a cashierless unmanned store that enables shopping without payment. Of course, a manned store having a cashier may also be used in a case where the multifunction peripheral 20 is installed.

The user may use a plurality of the stores 2, and one store 2 may be used by a plurality of users. However, since each of the store management server 10 and the multifunction peripheral 20 installed in the store 2 and the portable terminal apparatus 40 may have the functions described later, only the store 2 at one location and only the portable terminal apparatus 40 carried by one user are illustrated in FIG. 1.

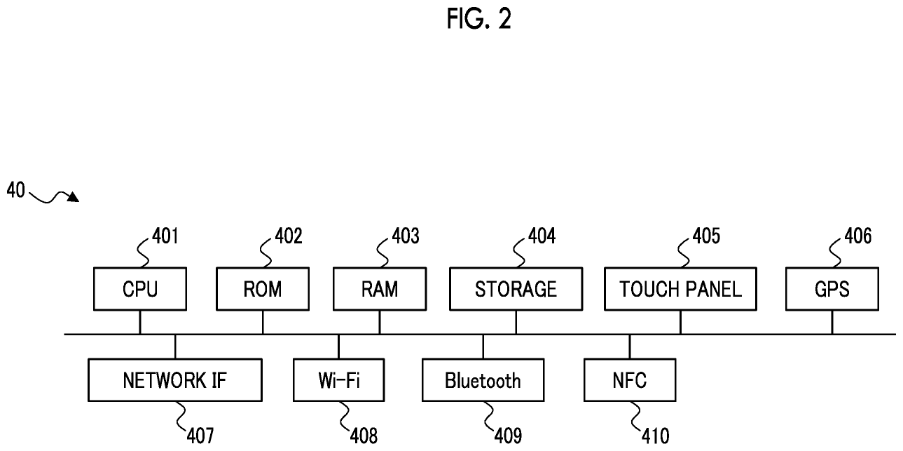

FIG. 2 is a hardware configuration diagram of the portable terminal apparatus 40 in the present exemplary embodiment. The portable terminal apparatus 40 is a terminal apparatus carried by the user, in which a computer is mounted. In the description of the present exemplary embodiment, while a smartphone is assumed as the portable terminal apparatus 40, the portable terminal apparatus 40 may be other portable terminal apparatuses such as a tablet terminal. The portable terminal apparatus 40 in the present exemplary embodiment can be implemented with a general-purpose hardware configuration that has already existed in the related art. That is, as illustrated in FIG. 2, the portable terminal apparatus 40 includes a CPU 401, a ROM 402, a RAM 403, a storage 404 as a memory that stores documents and various data, a touch panel 405 as a user interface that receives and displays inputs provided by the user, a global positioning system (GPS) 406 as a position measurer, a network interface (IF) 407 as a communicator that performs communication via the network 4, a communication interface 408 for performing wireless communication using Wi-Fi (registered trademark), a communication interface 409 for performing short range wireless communication using Bluetooth (registered trademark), and a communication interface 410 for performing short range wireless communication with the wireless communication apparatus installed in the entrance 6.

The wireless communication apparatus corresponding to NFC is incorporated in the entrance 6. Thus, even in a case where the wireless communication apparatus is indicated, the wireless communication apparatus may be referred to as the “entrance 6”.

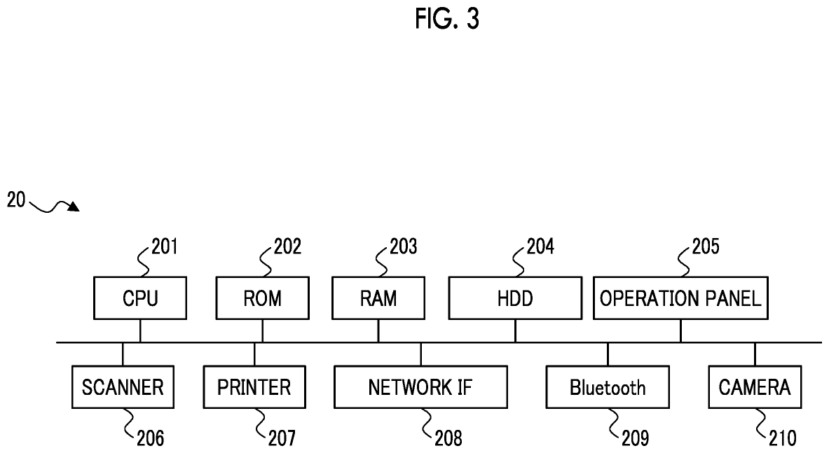

FIG. 3 is a hardware configuration diagram of the multifunction peripheral 20 in the present exemplary embodiment. The multifunction peripheral 20 is a form of image forming apparatus in which various functions such as a printing function, a copy function, and a scanner function are mounted, and is an apparatus in which a computer is incorporated. As illustrated in FIG. 3, the multifunction peripheral 20 includes a CPU 201, a ROM 202, a RAM 203, a hard disk drive (HDD) 204 as a memory that stores a scanned document and the like, an operation panel 205 as a user interface that receives inputs provided by the user and displays information, a scanner 206 that scans an original document set by the user and accumulates the scanned original document in the HDD 204 as electronic data, a printer 207 that prints an image on an output paper sheet in accordance with an instruction from a control program executed by the CPU 201, a network interface (IF) 208 as a communicator that performs communication via the network 4, a communication interface 209 that causes the multifunction peripheral 20 to function as the wireless communication apparatus by performing short range wireless communication in accordance with the communication standard called Bluetooth, and a camera 210 as an imager.

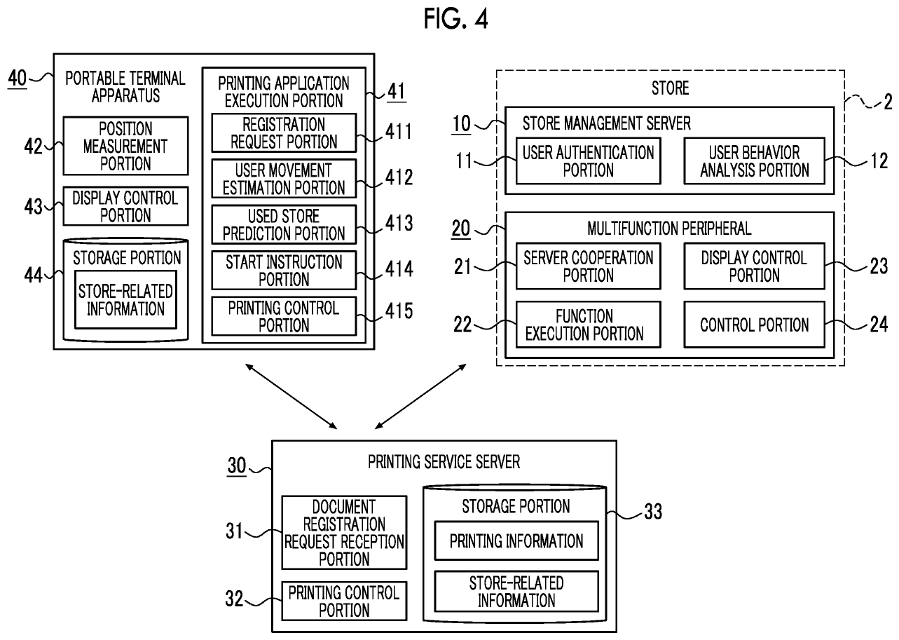

FIG. 4 is a block configuration diagram illustrating the printing service system in the present exemplary embodiment. The printing service system includes the store management server 10 and the multifunction peripheral 20 installed in the store 2, the printing service server 30, and the portable terminal apparatus 40. In each of the apparatuses 10, 20, 30, and 40, constituents not used in description of this exemplary embodiment are not illustrated in the drawings.

The store management server 10 manages information related to various types of equipment such as the wireless communication apparatus installed in the entrance 6 of the store 2 and the multifunction peripheral 20. The store management server 10 is implemented with a hardware configuration of a general-purpose server computer that has already existed in the related art. The store management server 10 in the present exemplary embodiment includes a user authentication portion 11 and a user behavior analysis portion 12. The user authentication portion 11 performs user authentication based on identification information (hereinafter, “user ID”) of the user scanned from the portable terminal apparatus 40 at the entrance 6. A user management database to be referred to in performing the user authentication may be stored and managed by the printing service server 30, or the store management server 10 may store registered users of the store 2. The user behavior analysis portion 12 analyzes in-store behavior of the user who has entered from the entrance 6. Particularly, the user behavior analysis portion 12 in the present exemplary embodiment specifies the user who intends to use the multifunction peripheral 20, from the behavior of the user. Each of the constituents 11 and 12 in the store management server 10 is implemented by a cooperative operation between a computer forming the store management server 10 and a program operated by a CPU mounted in the computer.

The multifunction peripheral 20 includes a server cooperation portion 21, a function execution portion 22, a display control portion 23, and a control portion 24. The server cooperation portion 21 operates in cooperation with the store management server 10. Specifically, the server cooperation portion 21 acquires the user ID of the user recognized as a user of the multifunction peripheral 20 among users authenticated in the store management server 10. The function execution portion 22 executes various functions including the printing function implemented in the multifunction peripheral 20. The display control portion 23 performs a display control of the operation panel 205 under control of the control portion 24. The control portion 24 controls an overall operation in the multifunction peripheral 20 by cooperating with each of the constituents 21 to 23.

Each of the constituents 21 to 24 in the multifunction peripheral 20 is implemented by a cooperative operation between a computer mounted in the multifunction peripheral 20 and a program operated by a CPU mounted in the computer.

The printing service server 30 is a server computer used for providing the printing service to the user. The printing service server 30 is implemented with a hardware configuration of a general-purpose server computer that has already existed in the related art. The printing service server 30 in the present exemplary embodiment includes a document registration request reception portion 31, a printing control portion 32, and a storage portion 33. The document registration request reception portion 31 receives a registration request of a document transmitted from the portable terminal apparatus 40. The printing control portion 32 performs transmission and reception of information such as output of a printing instruction to the multifunction peripheral 20, a printing control in the printing service, and the like in accordance with requests from the portable terminal apparatus 40. The storage portion 33 stores at least printing information and the store-related information. The printing information is information that is created in response to the registration request from the portable terminal apparatus 40 and that includes printing setting information including a data file (hereinafter, a “document file”) of an electronic document included in the registration request, identification information (hereinafter, “document ID”) of the document, the user ID of the user who has made the registration request, and furthermore, printing attributes such as the number of pages to be printed, color/grayscale, one-sided/two-sided printing, and a paper sheet size, a request reception date and time, and the like.

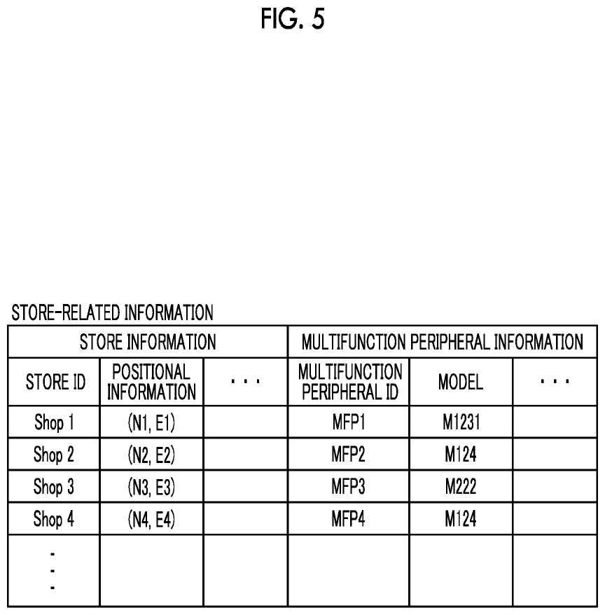

FIG. 5 is a diagram illustrating an example of a data configuration of the store-related information in the present exemplary embodiment. The store-related information includes information related to the store 2 in which the multifunction peripheral 20 that can print the document received by the printing service server 30 is installed. The store-related information in the present exemplary embodiment includes store information and multifunction peripheral information. The store information includes information related to the store 2 that can provide the printing service in cooperation with the printing service server 30. The store information includes identification information “store ID” for identifying the store 2 and “positional information” as installation positional information for specifying a position of the store. In the present exemplary embodiment, the store information is used together with position measurement information of the GPS 406 of the portable terminal apparatus 40. Thus, for example, indicating the position of the store 2 with a longitude and a latitude is desired. The multifunction peripheral information includes information related to the multifunction peripheral 20 installed in the store 2. The multifunction peripheral information includes identification information “multifunction peripheral ID” for identifying the multifunction peripheral 20 and a “model” of the multifunction peripheral 20. A plurality of the multifunction peripherals 20 may be installed in the store 2.

Each of the constituents 31 and 32 in the printing service server 30 is implemented by a cooperative operation between a computer forming the printing service server 30 and a program operated by a CPU mounted in the computer. In addition, the storage portion 33 is implemented by an HDD mounted in the printing service server 30. Alternatively, a RAM may be used, or an external memory may be used via a network.

The portable terminal apparatus 40 includes a printing application execution portion 41, a position measurement portion 42, a display control portion 43, and a storage portion 44. The printing application execution portion 41 executes an application for using the printing service provided by the printing service server 30. The printing application execution portion 41 includes a registration request portion 411, a user movement estimation portion 412, a used store prediction portion 413, a start instruction portion 414, and a printing control portion 415. The registration request portion 411 requests the printing service server 30 to register the document to be printed using the printing service, by transmitting the document file or the like to be printed. The user movement estimation portion 412 estimates a movement direction and a movement speed of the user by referring to a transition of position measurement data of the position measurement portion 42. The used store prediction portion 413 predicts the store that the user intends to use, based on user behavior estimated by the user movement estimation portion 412. The start instruction portion 414 provides a printing execution start instruction at a point when a movement time required for the user to arrive at the store 2 becomes less than or equal to a time (hereinafter, a “printing required time”) that is expected to be required for printing the document registered in the printing service server 30. The printing control portion 415 performs an operation control related to printing in the portable terminal apparatus 40.

The position measurement portion 42 acquires a current position in a case where the user is moving outside the store 2, in cooperation with the GPS 406. Since the user moves by carrying the portable terminal apparatus 40 a current position of the user always coincides with the current position of the portable terminal apparatus 40. The display control portion 43 controls display of the touch panel 405. The storage portion 44 stores the store-related information acquired from the printing service server 30.

Each of the constituents 41 to 43 in the portable terminal apparatus 40 is implemented by a cooperative operation between the computer forming the portable terminal apparatus 40 and a program operated by the CPU 401 mounted in the computer. In addition, the storage portion 44 is implemented by the storage 404 mounted in the portable terminal apparatus 40. Alternatively, the RAM 403 may be used, or an external memory may be used via a network.

In addition, the program used in the present exemplary embodiment may be not only provided by a communicator but also provided by storing the program in a computer readable recording medium such as a USB memory. The program provided from the communicator or from the recording medium is installed on a computer, and a CPU of the computer sequentially executes the program to implement various types of processing.

Next, an operation in the present exemplary embodiment will be described.

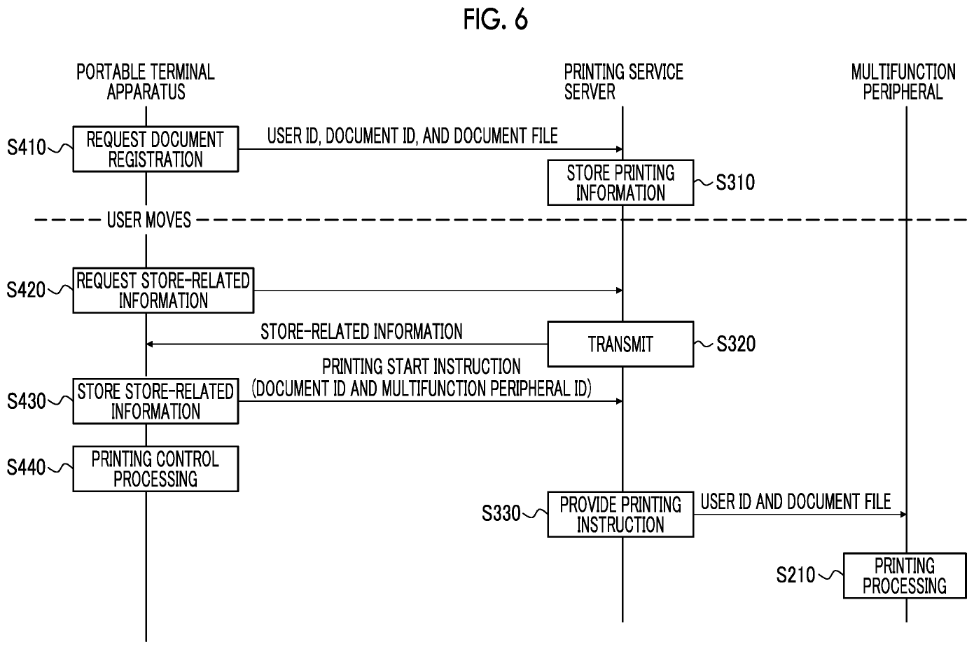

First, the user operates the portable terminal apparatus 40 to register the document file to be printed in the printing service server 30. In a case of performing this operation, the user is assumed to be outside the store 2. Hereinafter, processing from registration of the document file to obtaining of a printed matter by the user will be described using the sequence diagram illustrated in FIG. 6. In the following description, only one multifunction peripheral 20 is installed in the store 2. In addition, for convenience of description, the position of the store 2 will be described as being the same as a position of the multifunction peripheral 20 unless otherwise specified. In addition, for the user who has registered the document, use of the store 2 has the same meaning as use of the multifunction peripheral 20.

The user operates the portable terminal apparatus 40 to start the application of the printing service, thereby causing the printing application execution portion 41 to execute processing. In a case where the printing application execution portion 41 is started, the printing application execution portion 41 displays a document registration screen on the touch panel 405 of the portable terminal apparatus 40.

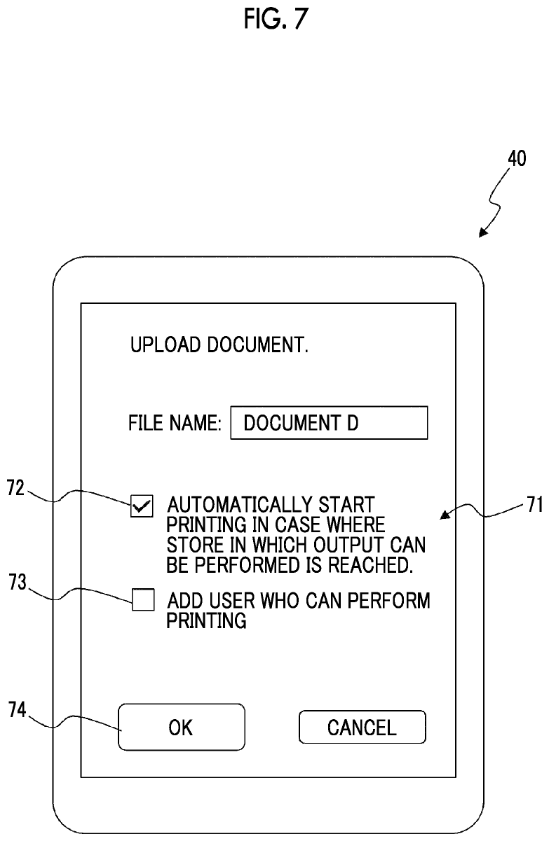

FIG. 7 is a diagram illustrating a display example of the document registration screen in the present exemplary embodiment. The user inputs a file name of the document to be printed from the document registration screen. As illustrated in FIG. 7, an inquiry message 71 as to whether or not to automatically start printing the document and a checkbox 72 corresponding to the inquiry message 71 are displayed on the document registration screen. The user designates whether or not to provide an automatic printing start instruction of the document by placing or not placing a check in the checkbox 72. Accordingly, in a case where the user intends to select to automatically start printing (hereinafter, referred to as “automatic printing”), the user places a check in the checkbox 72. Addition of the user will be described later.

In a case where the user designates the document file and whether or not to perform the automatic printing and then, selects an OK button 74, the registration request portion 411 transmits a document registration request including the user ID of the user of the portable terminal apparatus 40, the document file, and the document ID as the identification information of the document to the printing service server 30 (step S410).

In a case where the document registration request reception portion 31 in the printing service server 30 receives the document registration request transmitted from the portable terminal apparatus 40, the document registration request reception portion 31 creates the printing information including the user ID, the document ID, and the document file included in the document registration request and stores the printing information in the storage portion 33 (step S310). The printing information further includes the printing setting information, the request reception date and time, and the like that are referred to for calculating a reception date and time of the document registration request and the printing required time by referring to attribute information attached to the document file. The above document registration in the printing service server 30 is the same processing as job registration processing and does not correspond to a job execution instruction.

In a case where the document file is registered in the printing service server 30, the user starts moving toward the store 2 in which the multifunction peripheral 20 that the user intends to use is installed. While the present exemplary embodiment is described by assuming walking as means of movement of the user, other means of movement such as a vehicle may be used in a case where the current position of the user can be detected by the position measurement portion 42.

Next, the printing application execution portion 41 requests transmission of the store-related information (step S420). The printing control portion 32 in the printing service server 30 reads out the store-related information registered in the storage portion 33 and transmits the store-related information to the portable terminal apparatus 40 in response to the request from the portable terminal apparatus 40 (step S320). The printing application execution portion 41 stores the store-related information transmitted in response to the transmission request in the storage portion 44 (step S430).

The printing service server 30 may store and manage the store-related information corresponding to the stores 2 that are deployed nationwide and that provide the printing service. Accordingly, since acquiring all the store-related information may not be desired, for example, the printing application execution portion 41 may transmit the current position of the portable terminal apparatus 40 in requesting the transmission of the store-related information. The printing control portion 32 in the printing service server 30 may narrow down the store-related information to the store-related information corresponding to the store 2 within a predetermined range from the current position of the portable terminal apparatus 40 or to a predetermined number of the stores 2 in order from the store 2 closest to the current position, and transmit the store-related information. In addition, the printing application execution portion 41 may transmit the means of movement of the user together, thereby causing the printing control portion 32 in the printing service server 30 to determine the predetermined range or the predetermined number based on a movement range assumed from the means of movement.

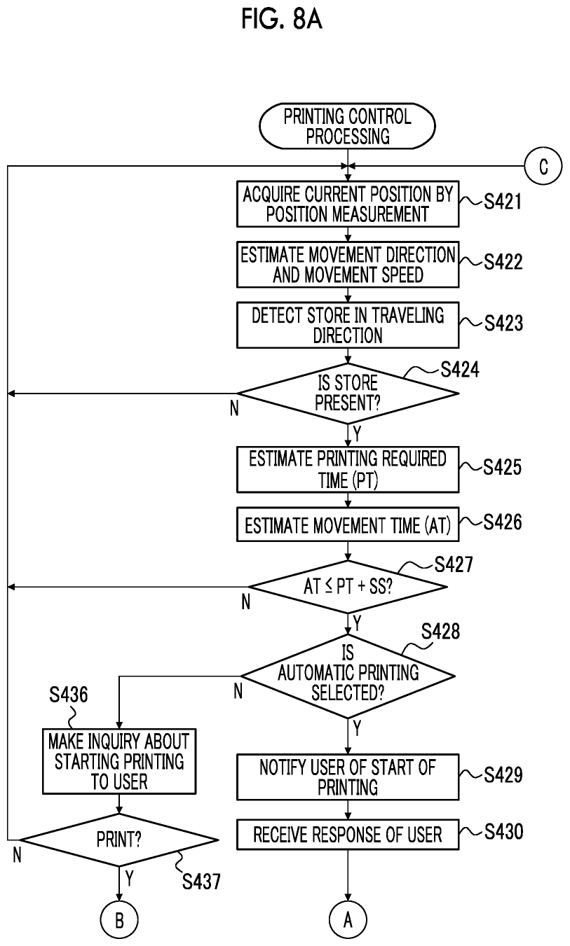

In addition, in a case where the user starts moving, the printing application execution portion 41 executes the printing control processing (step S440). Hereinafter, characteristic printing control processing in the present exemplary embodiment will be described using the flowcharts illustrated in FIGS. 8A and 8B.

As described above, at a point when the user has registered the document, the user is outside the store 2 and is walking toward the target store 2. The position measurement portion 42 acquires the current position of the moving user (step S421). The acquired current position is stored for calculating the movement speed and the like.

Next, the user movement estimation portion 412 estimates the movement speed and the movement direction of the user based on calculation by analyzing a transition of the current position obtained by the position measurement of the position measurement portion 42 (step S422).

Next, the used store prediction portion 413 predicts the store 2, that is, the multifunction peripheral 20 that the user intends to use by referring to the movement direction of the user, that is, a traveling direction of the user. In order to do so, the used store prediction portion 413 detects the store 2 present in the traveling direction of the user (step S423). In a strict sense, determination as to whether or not the store 2 is present is not necessarily limited to a straight line of the traveling direction and is performed within a predetermined range having a predetermined angle from the traveling direction in which the user is assumed to move. In addition, by considering the movement speed of the user, whether or not the store 2 is present may be determined by referring to a movement time and a movement distance from the current position of the user. The used store prediction portion 413 determines whether or not the store 2 is present by referring to the current position of the user, the movement direction, the movement speed, and the store information of the store-related information stored in the storage portion 44. The used store prediction portion 413 predicts the detected store 2 as the store 2 that the user intends to use.

In a case where the store 2 is not detected in the traveling direction of the user (N in step S424), the printing control portion 415 transitions the processing to step S421 and causes the position measurement portion 42 to execute the position measurement.

In step S421, the position measurement portion 42 may periodically perform the position measurement. As an execution interval of the position measurement is increased, the movement distance of the user is increased. Thus, a plurality of the stores 2 are likely to be found at the same time in step S423. On the other hand, a load exerted on the portable terminal apparatus 40 is decreased. Since the stores 2 are expected to be scattered at certain distances, the position measurement portion 42 may perform the position measurement at a desired time interval, for example, every few minutes, so that one store is detected at a time. In addition, in a case where a plurality of the stores 2 are found at the same time, the store 2 that is closest to the current position of the user within the predetermined range from the traveling direction of the user may be predicted as the store 2 that the user intends to use, by referring to the positional information of each store 2. Alternatively, the plurality of detected stores 2 may be displayed in a list, and the user may select the store 2 to be used for printing.

In a case where the store 2 is detected in the traveling direction of the user (Y in step S424), the used store prediction portion 413 predicts that the user is walking toward the detected store 2 as a destination. In this case, the printing control portion 415 calculates the printing required time (step S425).

The printing required time depends on the attribute information such as a size of the document and printing attributes such as the number of copies to be printed and color/grayscale, and also depends on performance of a multifunction peripheral. Accordingly, the printing control portion 415 acquires information related to performance of the multifunction peripheral 20 to be used for printing and acquires information related to the document as needed by, for example, making an inquiry to the printing service server 30. Since the performance of the multifunction peripheral 20 can be determined from the model of the multifunction peripheral 20, the printing control portion 415 may acquire the model from the printing service server 30 and specify the information related to the performance of the multifunction peripheral 20, or may cause the printing service server 30 to acquire the model and to transmit the information related to the performance. Furthermore, a load state or an operation state such as a power-saving mode of the multifunction peripheral 20 may be acquired and used for calculating the printing required time. By using information related to a state of the multifunction peripheral 20, for example, a time required for recovery from a power-saving state can be reflected on the printing required time. Thus, the printing required time can be more accurately calculated.

In addition, the printing control portion 415 calculates the movement time from the current position of the user to an installation position of the multifunction peripheral 20 based on the current position, the movement direction, and the movement speed of the user and the position of the multifunction peripheral 20 (step S426). In the present exemplary embodiment, the movement time is calculated by handling the position of the store 2 as the installation position of the multifunction peripheral 20 for convenience. However, in a case of the store 2 having a wide lot area, a movement time or a distance from the position indicated by the positional information of the store 2 included in the store-related information to the installation position of the multifunction peripheral 20 may be set in the store-related information, and the movement time may be more accurately calculated by referring to the set information. The processing in step S425 and step S426 may be performed in reverse order.

Here, in a case where the movement time (denoted by a symbol “AT”) is not less than or equal to a sum of the printing required time (denoted by a symbol “PT”) and a permissible error (denoted by a symbol “SS”) (N in step S427), that is, in a case where a time required for movement is longer than a time required for printing, starting printing of the document at the current point causes printing to be finished before the user arrives at the multifunction peripheral 20. Accordingly, a return is made to step S421 without starting printing.

In the present exemplary embodiment, a return is made to step S421. Since the user walks along a road, there is a possibility that the traveling direction of the user changes instantly, for example, at a right angle, in a case where a corner is present. That is, there is a possibility that the store 2 not to be used is erroneously detected by the processing in step S423 in a case where the user is not walking toward the intended store 2. In order to correct this, a return is made to step S421 so that the processing is restarted from the beginning. The intended store 2 may not be detected in a case where the user walking toward the intended store 2 changes the direction at a corner. However, since the user eventually walks toward the intended store 2, the intended store 2 is detected again. In addition, in a case where the user does not change the traveling direction, the same store 2 is detected every time, and the movement time (AT) eventually becomes less than or equal to the sum of the printing required time (PT) and the permissible error (SS). In a case of the same store 2, the printing required time does not change. Thus, the printing required time that has been calculated once may be temporarily stored and processed so that the printing required time does not need to be calculated again in step S425.

In a case where the movement time (AT) becomes less than or equal to the sum of the printing required time (PT) and the permissible error (SS) (Y in step S427), the user approaches the store 2 as a destination to a certain extent. In a case where printing is started at this point, printing can be finished in time in a case where the user arrives at the installation position of the multifunction peripheral 20. In other words, the user can be said to have approached the multifunction peripheral 20 to a distance in which printing is estimated to be finished in time at a point when the user arrives at the installation position of the multifunction peripheral 20. At this point, in a case where the user selects the automatic printing from the document registration screen (Y in step S428), the printing control portion 415 notifies the user that printing is automatically started (step S429). In the present exemplary embodiment, even the automatic selection is finally checked with the user by notifying the user of the start of printing. However, the notification may not be needed. That is, the start instruction portion 414 may provide the automatic printing start instruction to the printing service server 30 at a point when the movement time (AT) becomes less than or equal to the sum of the printing required time (PT) and the permissible error (SS). Alternatively, only the notification of the start of the printing may be performed without finally checking with the user. The notification to the user is executed by the printing control portion 415 in cooperation with the display control portion 43. That is, the display control portion 43 displays a printing start notification screen on the touch panel 405 in accordance with an instruction from the printing control portion 415.

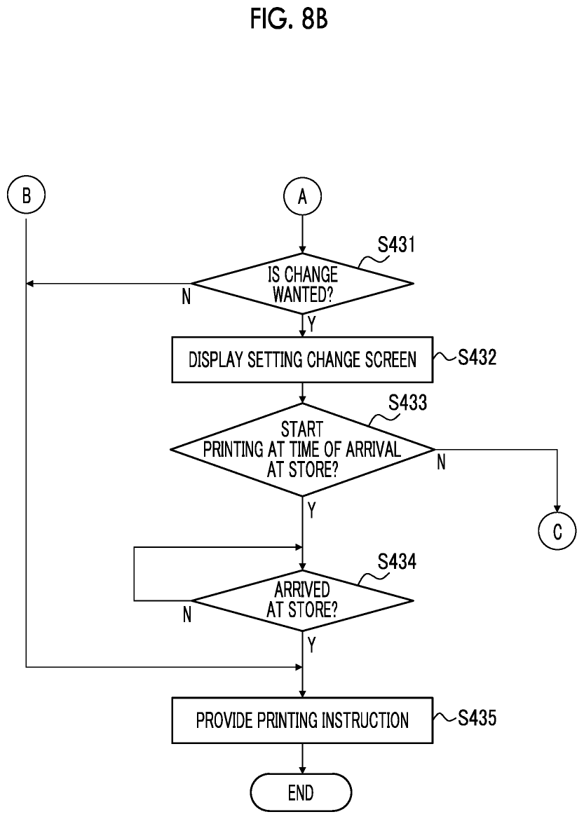

FIG. 9 is a diagram illustrating a display example of the printing start notification screen in the present exemplary embodiment. A check message and buttons 76 and 78 for finally checking whether or not to execute printing are displayed on the printing start notification screen. In a case where the printing start notification screen is displayed, the user designates whether or not to start printing by selecting any of the buttons 76 and 78.

In FIG. 9, after “SS” seconds is illustrated. That is, the permissible error (SS) in the above description is a time that is predicted to be required for the user from reception of the notification to the button operation, and is a time permitted until the button operation. The display control portion 43 may display “SS” displayed on the printing start notification screen to be counted down in accordance with an elapse of time from the screen display, that is, to indicate a remaining time in which the button operation is to be performed in order to finish printing in time at a point when the user arrives at the installation position of the multifunction peripheral 20. In addition, in a case where the user selects the “Yes” button 76 before SS being counted down becomes 0 seconds, printing is logically finished earlier by the remaining time. Thus, the printing control portion 415 may perform a control in internal processing to hold the printing start instruction until SS being counted down becomes 0 seconds after the selection of the “Yes” button 76 by the user is received.

As a result of the button selection by the user, in other words, in a case where a respond of the user to the automatic printing is received (step S430), and the user selects the “Yes” button 76, that is, in a case where the user does not want to change a setting of the automatic printing set at a time of the document registration (N in step S431), the start instruction portion 414 provides the printing start instruction to the printing service server 30 in accordance with an instruction from the printing control portion 415 (step S435). While the printing start instruction for the printing service server 30 is illustrated in FIG. 6, the start instruction portion 414 includes the document ID of the document to be printed and the multifunction peripheral ID in the printing start instruction as illustrated in FIG. 6.

As illustrated in FIG. 6, in a case where the printing control portion 32 in the printing service server 30 receives the printing start instruction from the portable terminal apparatus 40, the printing control portion 32 provides the printing instruction to the multifunction peripheral 20 specified by the multifunction peripheral ID (step S330). In providing the printing instruction to the multifunction peripheral 20, the printing control portion 32 acquires the document file specified by the document ID from the printing information and transmits the document file to the multifunction peripheral 20 together with the user ID of the user who has provided the printing instruction (step S330).

The control portion 24 in the multifunction peripheral 20 causes the function execution portion 22 to execute the printing processing of the transmitted document file in accordance with the printing instruction from the printing service server 30 (step S210).

With reference to FIG. 8B again, in a case where the user selects the “No” button 78 from the printing start notification screen, that is, in a case where the user wants to change the setting of the automatic printing set at the time of the document registration (N in step S431), the display control portion 43 displays a setting change screen on the touch panel 405 in accordance with an instruction from the printing control portion 415 (step S432).

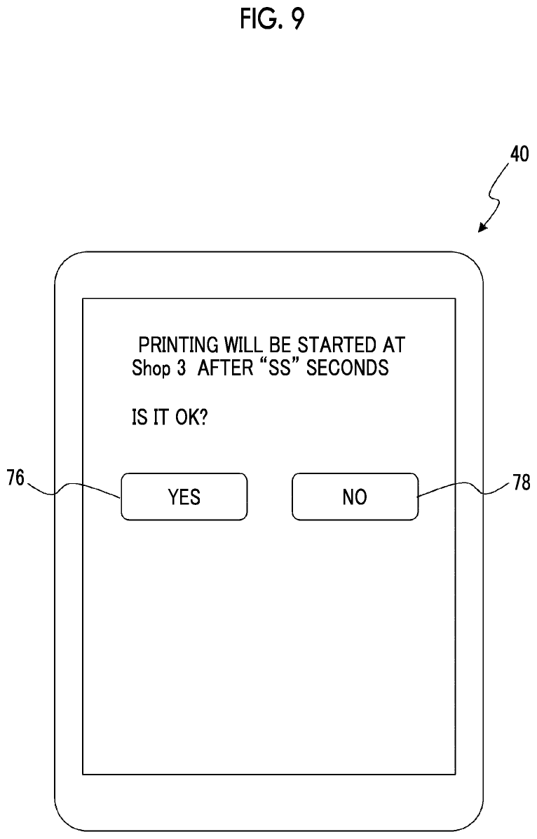

FIG. 10 is a diagram illustrating a display example of the setting change screen in the present exemplary embodiment. Setting contents that can be changed from the automatic printing are displayed in a list on the setting change screen. The user selects an intended change from the list and selects an OK button 88. The printing control portion 415 controls printing of the document in accordance with content of the change selected by the user. A back button 90 is selected in order to select the automatic printing again.

In a case where the user selects a message 80 of “Start printing at time of arrival at store.” from the setting change screen (Yin step S433), the printing control portion 415 cancels the setting of the automatic printing and does not provide the printing execution start instruction at the current point. The processing waits until the user arrives at the store 2.

Arrival of the user at the store 2 can be detected by holding the portable terminal apparatus 40 to the entrance 6 of the store 2. In a case where the processing waits until the user arrives at the store 2 (N in step S434), and the user arrives at the store 2 (Y in step S434), the start instruction portion 414 provides the printing start instruction to the printing service server 30 in accordance with an instruction from the printing control portion 415 (step S435). Operations of the printing service server 30 and the multifunction peripheral 20 after the printing instruction have already been described above and thus, will not be described here.

In a case where the user selects a message 82, 84, or 86 of other setting changes (N in step S433), the printing control portion 415 cancels the setting of the automatic printing and does not provide the printing start instruction at the current point. The processing returns to step S421.

In a case where the message 82 of “Print at another store. (Designate store)” is selected, the user inputs information for specifying another store 2 from an input screen not illustrated. Alternatively, the display control portion 43 may display stores stored in step S430 in a list and cause the user to select. The printing control portion 415 executes the processing from step S425 for the store 2 designated by the user. In a case where the message 84 of “Print at another store. (Receive suggestion from application.)” is selected, a name and the like of a recommended store 2 are displayed on a store display screen not illustrated. The printing control portion 415 executes the processing from step S425 for the recommended store 2 after checking with the user. For example, the recommended store 2 may be selected from the store 2 second closest to the current position, the store 2 in which the multifunction peripheral 20 having high performance is installed, or the store 2 having a small number of visitors. In a case where the message 86 of “Do not print this time.” is selected, the printing control portion 415 returns to step S421 without performing any special processing.

In a case where the user does not select the automatic printing from the document registration screen (N in step S428), the printing control portion 415 does not automatically start printing, but informs the user of a state where printing can be performed and makes an inquiry as to whether or not to start printing to the user. In order to do so, the display control portion 43 makes an inquiry as to whether or not to perform printing to the user by displaying an inquiry screen on the touch panel 405 in accordance with an instruction from the printing control portion 415 (step S436).

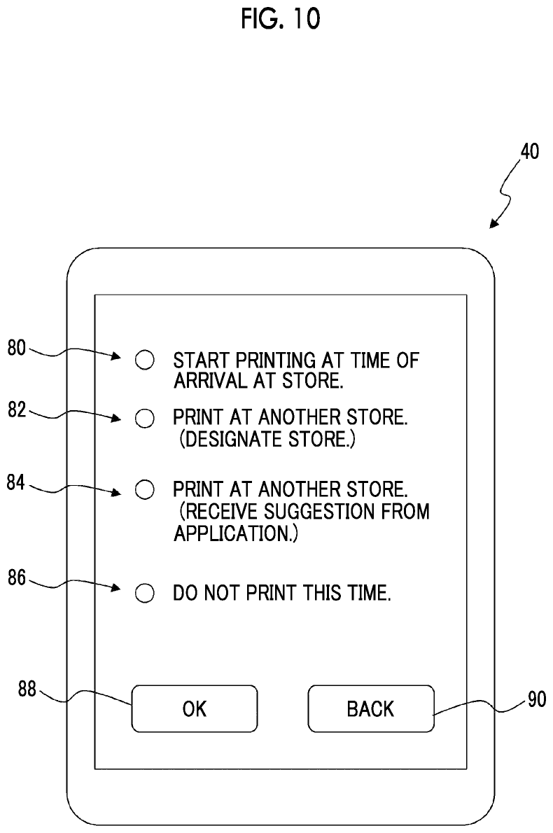

FIG. 11 is a diagram illustrating a display example of the inquiry screen in the present exemplary embodiment. As described above, the inquiry screen is displayed in a case where the user does not select the automatic printing. A message for notifying the user of the state where printing can be performed and of the store 2 for printing, and buttons 92 and 94 for the user to select whether or not to perform printing are displayed on the inquiry screen.

In a case where the user wants printing (Y in step S437), that is, in a case where the user selects a “Yes” button 92, the start instruction portion 414 provides the printing start instruction to the printing service server 30 in accordance with an instruction from the printing control portion 415 (step S435). Operations of the printing service server 30 and the multifunction peripheral 20 after the printing instruction have already been described above and thus, will not be described here.

In a case where the user does not want printing (N in step S437), that is, in a case where the user selects a “No” button 94, the printing control portion 415 returns the processing to step S421 without executing printing at the current point.

According to the present exemplary embodiment, by doing the above, printing may be executed such that printing is finished in time at a point when the user arrives at the installation position of the multifunction peripheral 20, without causing the user to output the printing start instruction of the registered document.

As described above, the multifunction peripheral 20 starts printing in accordance with the printing instruction from the printing service server 30. In the store 2 that can be used by an unspecified person, visitors can basically use the multifunction peripheral 20. Since a person (hereinafter, referred to as a “registrant”) who has registered the document in the printing service server 30 is the user of the portable terminal apparatus 40 outside the store 2, printing is controlled so that printing is finished at a point when the user arrives at the installation position of the multifunction peripheral 20. However, in actuality, after the user starts printing, a case where the user does not arrive at the store 2 at a point of the finish of printing because the user stops off before arriving at the store 2, or because the road meanders more than expected can be assumed. In this case, there is a possibility that a third party in the store 2 takes the printed matter.

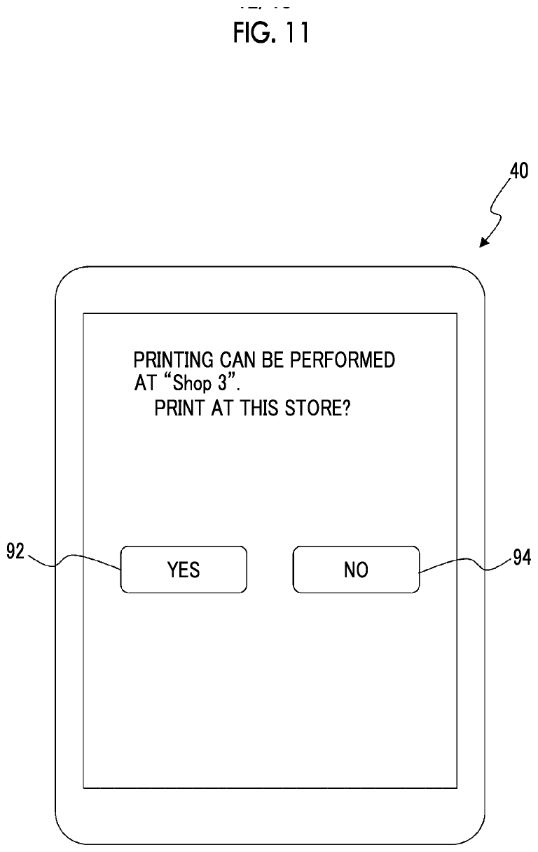

Therefore, in a case of starting printing in accordance with the printing instruction, the multifunction peripheral 20 in the present exemplary embodiment executes the printing processing in order to prevent unauthorized acquisition of the printed matter and to enable a normal registrant to acquire the printed matter. Hereinafter, the printing processing executed by the multifunction peripheral 20 in the present exemplary embodiment will be described using the flowchart illustrated in FIG. 12.

As described above, in a case where the control portion 24 receives the printing instruction from the printing service server 30, the control portion 24 causes the function execution portion 22 to start printing (step S211). At a point of the start of printing, an assumption that the registrant has not arrived at the store 2 can be made. At this point, in a case where the multifunction peripheral 20 is used by a visitor other than the registrant, there is a possibility of occurrence of an unexpected event. Thus, the control portion 24 restricts use of the multifunction peripheral 20. Specifically, an operation from the operation panel 205 is restricted so that a panel operation is not received (step S212). At this point, the display control portion 23 informs the visitor intending to use the multifunction peripheral 20 that the operation is restricted, by displaying a message indicating that the operation is currently restricted, on the operation panel 205 in accordance with an instruction from the control portion 24.

In the present exemplary embodiment, a case where the store 2 is a cashierless unmanned store is assumed. In a case of a cashierless unmanned store, a person of use of the store 2 is subjected to the user authentication by holding the carried portable terminal apparatus 40 to the entrance 6. The user authentication portion 11 performs the user authentication based on personal information of the user scanned from the portable terminal apparatus 40. The user can enter the store by successfully passing the user authentication performed by the user authentication portion 11. While briefly described above, user authentication processing may be the same as in the related art and thus, will not be described in detail.

While illustration is not provided in FIG. 1, a plurality of monitoring cameras are installed on a cashierless unmanned store system in the store 2, and the user behavior analysis portion 12 in the store management server 10 is constantly monitoring the behavior of the user by analyzing a captured image of each monitoring camera. Consequently, the store management server 10 can specify the user intending to use the multifunction peripheral 20 from a motion of the user who is the visitor.

In a case where the user (hereinafter, referred to as the “person of use”) intending to use the multifunction peripheral 20 can be specified, the store management server 10 notifies the multifunction peripheral 20 of the person of use. The person of use of the multifunction peripheral 20 can be specified by receiving the notification from the store management server 10 via the server cooperation portion 21 (step S213). While the person of use of the multifunction peripheral 20 is specified in cooperation with the system of the cashierless unmanned store in the present exemplary embodiment, the person of use of the multifunction peripheral 20 may be specified using the camera 210 included in the multifunction peripheral 20.

Here, in a case where the person of use of the multifunction peripheral 20 is the registrant (Yin step S214), the registrant, that is, the user of the portable terminal apparatus 40, can use the multifunction peripheral 20 without a problem in terms of security. Thus, the control portion 24 releases the restriction on the operation of the operation panel 205 (step S215). Basically, in a case where the user of the portable terminal apparatus 40 arrives at the installation position of the multifunction peripheral 20, printing is finished. However, since a case where printing is not finished for any reason may also be assumed (N in step S216), a transition is not made to the subsequent processing until printing is finished. In a case where printing is finished (Yin step S216), the multifunction peripheral 20 performs billing for the user (step S217). Since the store 2 is a cashierless unmanned store, the multifunction peripheral 20, for example, performs billing in cooperation with the store management server 10 without human effort using predetermined means.

On the other hand, in a case where the person of use of the multifunction peripheral 20 is not the registrant (N in step S214), the control portion 24 controls display of the operation panel 205 in cooperation with the display control portion 23 (step S218). For example, the display control portion 23 displays an alert message on the operation panel 205 by controlling the display of the operation panel 205.

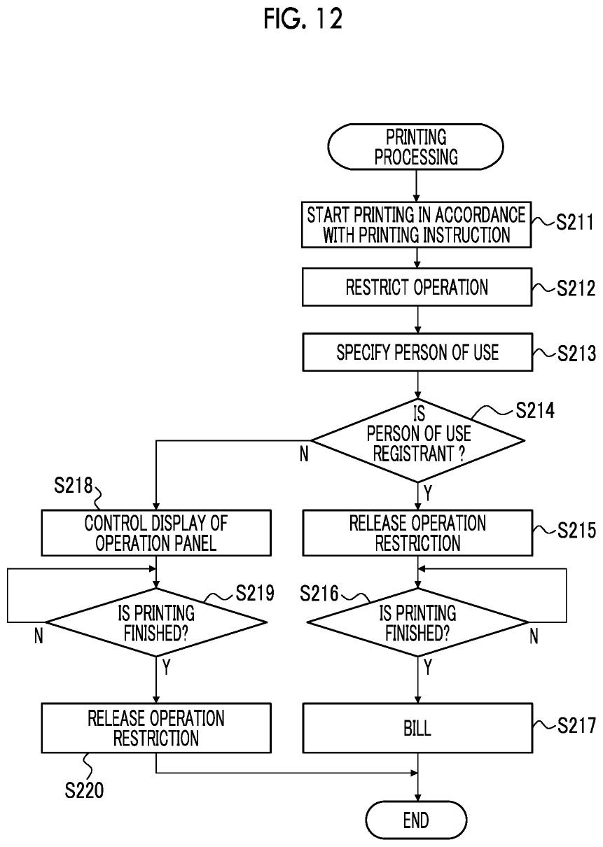

FIG. 13 is a diagram illustrating a display example of an alert screen in the present exemplary embodiment. The alert screen is a screen for displaying the alert message illustrated in FIG. 13 on the operation panel 205. A mechanism for physically preventing acquisition of the printed matter from an output tray to which the printed matter is output is not provided in the store 2 in the present exemplary embodiment. However, since the alert message displayed on the operation panel 205 in the present exemplary embodiment includes a name of the person of use of the multifunction peripheral 20, the person of use can be informed that the individual person of use of the multifunction peripheral 20 is specified. Accordingly, displaying the alert message on the operation panel 205 is considered to achieve an effect of suppressing unauthorized activity.

The acquisition of the printed matter from the output tray may be detectable by providing a sensor in the multifunction peripheral 20. In a case where the sensor detects an operation of acquiring the printed matter from the output tray, and the visitor specified by the monitoring camera of the store 2 or by the camera 210 of the multifunction peripheral 20 is not the registrant, the display control portion 23 may output the alert message to the operation panel 205.

While restricting an operation of the multifunction peripheral 20 may prevent unauthorized acquisition of the printed matter, disabling all of the plurality of functions provided by the multifunction peripheral 20 is considered to be inconvenient for the visitor. For example, a function that does not accompany printing, in other words, a function that does not generate the printed matter and thus, does not require an operation of the output tray, is considered to be used by the visitor other than the registrant without a problem. Therefore, in the present exemplary embodiment, a part of the functions provided by the multifunction peripheral 20 can be used.

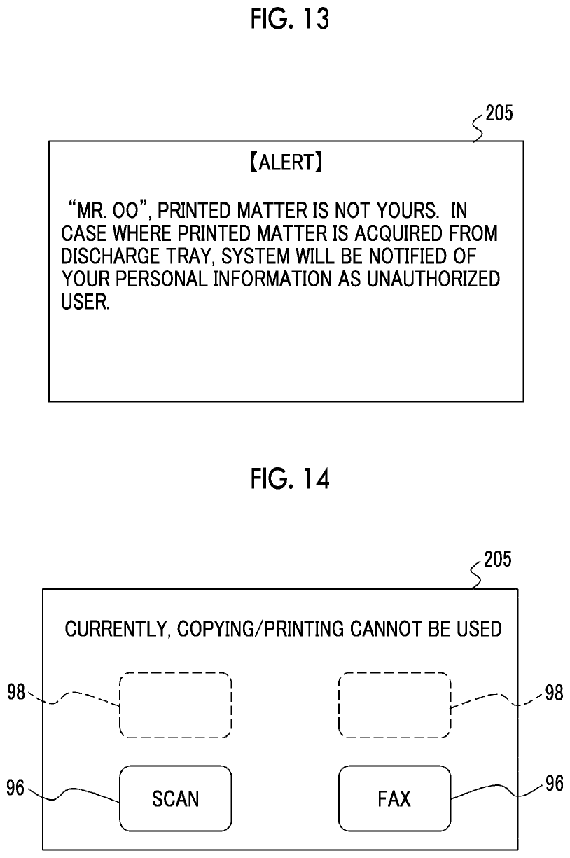

FIG. 14 is a diagram illustrating a display example of the operation panel 205 of the multifunction peripheral 20 in the present exemplary embodiment. As illustrated in FIG. 14, the display control portion 23 displays a button 96 for executing a function such as scanning or FAX that does not use the printing function such as copying or printing, to be selectable as usual. On the other hand, the display control portion 23 displays a button 98 for executing a function such as copying or printing that uses the printing function accompanying printing to generate the printed matter, in a different display form from the button 96 so that the button 98 can be recognized as not being selectable. In actuality, in a case where the button 96 is operated, the control portion 24 permits execution of the function corresponding to the selected button 96. That is, the function is executed as usual. On the other hand, even in a case where the button 98 is operated, the control portion 24 controls the function corresponding to the selected button 98 not to be executed.

The alert message illustrated in FIG. 13 may be displayed on the operation panel 205 together with the buttons 96 and 98 illustrated in FIG. 14.

The display of the operation panel 205 is controlled until printing by the registrant is finished (N in step S219). In a case where printing is finished, and the sensor detects acquisition of the printed matter by the registrant (Y in step S219), the control portion 24 releases the restriction on the operation of the operation panel 205 (step S220). Accordingly, the multifunction peripheral 20 can be used as usual.

According to the present exemplary embodiment, even in a case where a visitor other than the registrant is in the store, printing can be executed. Meanwhile, for a visitor who intends to acquire the printed matter from the multifunction peripheral 20 in an unauthorized manner, the unauthorized activity can be prevented by the alert message. In addition, a function that does not use the printing function can be used considering convenience of use of the multifunction peripheral 20 by the visitor.

The registrant may intend to have a person other than the registrant acquire the printed matter as in a case where the registrant has registered the document in the printing service server 30 but cannot go to take the printed matter, or as in a case where, for example, the registrant intends to have a person heading toward a customer additionally carry the document. Therefore, in the present exemplary embodiment, a function that enables even a user other than the user who has registered the document in the printing service server 30 to provide the printing start instruction of the registered document is provided.

That is, on the document registration screen illustrated in FIG. 7, in a case where the user places a check in the checkbox 73 and selects the OK button 74, an additional user setting screen is displayed on the touch panel 405.

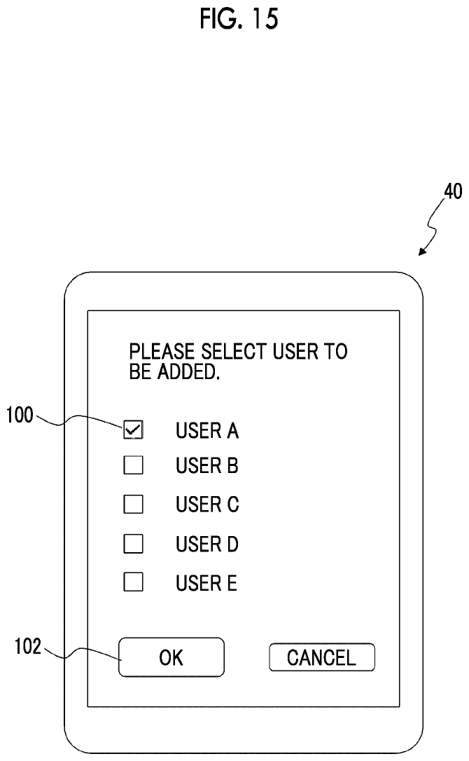

FIG. 15 is a diagram illustrating a display example of a user addition screen in the present exemplary embodiment. A list of users who are permitted to perform printing is displayed on the user addition screen. For example, users to be displayed are persons in the same department as the user of the portable terminal apparatus 40. In this case, the portable terminal apparatus 40 makes an inquiry to a company system and acquires a list of employees of an identical department extracted by searching a predetermined database of employee information and the like. The information to be acquired includes the name and the user ID of each user. In a case where the registrant selects a user capable of printing the document by placing a check in a checkbox 100 corresponding to the user permitted to print the document and then, selects an OK button 102, the registration request portion 411 in step S410 illustrated in FIG. 6 registers the user capable of printing the document in the printing service server 30 by transmitting the user ID, the document ID, the document file, and also the user ID of the selected user to the printing service server 30.

That is, in a case where the document registration request reception portion 31 in the printing service server 30 receives the document registration request transmitted from the portable terminal apparatus 40, the document registration request reception portion 31 creates the printing information including the user ID, the document ID, the document file, and the user ID of the user capable of printing the document included in the document registration request and stores the printing information in the storage portion 33 in step S310 illustrated in FIG. 6.

Subsequent processing may be performed by executing the above processing. However, since adding the user results in a plurality of users capable of printing, the above processing is executed in the portable terminal apparatus 40 carried by each user.

For example, an assumption is made that in a case where two users, that is, the user (the “registrant”) who has registered the document and the user (hereinafter, an “additional person”) added by the registrant as the user capable of printing, can provide the printing start instruction of the document, the registrant intends to have the additional person provide the printing start instruction.

In this case, in a case where the registrant is not outside, that is, not moving, the store 2 in which printing can be performed is not found (N in step S424). However, the “No” button 78 may be selected on at least the printing start notification screen (FIG. 9), and then, the message 86 of “Do not print this time.” may be selected on the setting change screen (FIG. 10). On the other hand, the additional person may select the “Yes” button 76 on the printing start notification screen (FIG. 9) that will be eventually displayed by walking toward the intended store 2. Consequently, the printing service server 30 provides the printing instruction of the document to the multifunction peripheral 20 in accordance with the printing start instruction from the portable terminal apparatus 40 carried by the additional person.

According to the present exemplary embodiment, by doing the above, the registrant may have another user provide the printing start instruction.

While the user capable of printing can be added on the document registration screen in the above description, the user may be addable even after document registration by displaying the user addition screen (FIG. 15) without passing via the document registration screen (FIG. 7).

In addition, while a case of application to the printing service in which the document is registered in advance is illustratively described in the present exemplary embodiment, the document does not need to be registered in advance. For example, the document file may be transmitted to the printing service server 30 together with the printing start instruction or may be directly transmitted to the multifunction peripheral 20.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Supplementary Note

(((1)))

A portable terminal apparatus comprising:
a processor configured to:
   estimate a movement direction of a user carrying the portable terminal apparatus from a transition of a current position;
   from among image forming apparatuses capable of printing a document file to be printed, predict an image forming apparatus to be used for printing the document file by the user, by referring to the movement direction of the user; and
   provide a printing start instruction of the document file from the image forming apparatus in a case where the user has approached the image forming apparatus to a distance in which printing is estimated to be finished at a point when the user arrives at an installation position of the image forming apparatus.

(((2)))

The portable terminal apparatus according to (((1))), wherein the processor is configured to:
cause the user to designate whether or not to provide an automatic printing start instruction of the document file.

(((3)))

The portable terminal apparatus according to (((2))), wherein the processor is configured to:
in a case where the automatic printing start instruction is designated, provide an instruction to automatically start printing the document file in a case where the user has approached to the distance.

(((4)))

The portable terminal apparatus according to (((1))), wherein the processor is configured to:
notify the user that printing of the document file is automatically started.

(((5)))

The portable terminal apparatus according to (((4))), wherein the processor is configured to:
in a case where the user has changed setting content related to printing in response to the notification, control printing of the document file in accordance with the changed content.

(((6)))

The portable terminal apparatus according to (((1))), wherein the processor is configured to:
in a case where an automatic printing start instruction is not designated, make an inquiry to the user as to whether or not to start printing the document file in a case where the user has approached the image forming apparatus to the distance.

(((7)))

The portable terminal apparatus according to (((1))), wherein the processor is configured to:
acquire installation positional information of each image forming apparatus capable of printing the document file; and
predict an image forming apparatus installed closest to a current position of the user within a predetermined range in the movement direction, as the image forming apparatus to be used for printing the document file by the user.

(((8)))

A printing service system comprising:
at least one portable terminal apparatus according to (((1)));
an image forming apparatus including at least a processor and a user interface; and a service server that includes a processor and provides a printing instruction to the image forming apparatus in accordance with a printing start instruction from the portable terminal apparatus,
wherein the processor included in the image forming apparatus is configured to:
   restrict use of the image forming apparatus by another user other than a user carrying the portable terminal apparatus, from a start to a finish of printing in accordance with the printing instruction from the service server.

(((9)))

The printing service system according to (((8))), wherein the processor included in the image forming apparatus is configured to:
restrict an operation of the user interface from the start to the finish of printing in accordance with the printing instruction from the service server.

(((10)))

The printing service system according to (((8))), wherein the processor included in the image forming apparatus is configured to:
permit use of a function that does not use a printing function, among a plurality of implemented functions.

(((11)))

The printing service system according to (((8))),
wherein the image forming apparatus further includes
   an imager that images a user operating the image forming apparatus,
   an output tray to which a printed matter is output, and
   a sensor that detects an operation of acquiring the printed matter from the output tray, and
the processor included in the image forming apparatus is configured to:
   in a case where the operation of acquiring the printed matter from the output tray by the other user is detected, output an alert message to the user interface.

(((12)))

The printing service system according to (((11))), wherein the processor included in the image forming apparatus is configured to:
in a case where the operation of acquiring the printed matter by the user carrying the portable terminal apparatus is detected, release the restriction on the use of the image forming apparatus.

(((13)))

The printing service system according to (((8))),
wherein the processor included in the portable terminal apparatus is configured to:
   register a user capable of printing the document file in the service server in accordance with an instruction from the user, and
the processor included in the service server is configured to:
   provide the printing instruction of the document file to the image forming apparatus in accordance with the printing start instruction from the portable terminal apparatus carried by the user capable of printing the document file.

(((14)))

A program causing a computer to implement:
a function of estimating a movement direction of a user carrying a portable terminal apparatus from a transition of a current position;
a function of, from among image forming apparatuses capable of printing a document file to be printed, predicting an image forming apparatus to be used for printing the document file by the user, by referring to the movement direction of the user; and
a function of providing a printing start instruction of the document file from the image forming apparatus in a case where the user has approached the image forming apparatus to a distance in which printing is estimated to be finished at a point when the user arrives at an installation position of the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A portable terminal apparatus comprising:
a processor configured to:
estimate a movement direction of a user carrying the portable terminal apparatus from a transition of a current position;
from among image forming apparatuses capable of printing a document file to be printed, predict an image forming apparatus to be used for printing the document file by the user, by referring to the movement direction of the user; and
provide a printing start instruction of the document file from the image forming apparatus in a case where the user has approached the image forming apparatus to a distance in which printing is estimated to be finished at a point when the user arrives at an installation position of the image forming apparatus.

2. The portable terminal apparatus according to claim 1, wherein the processor is configured to:
cause the user to designate whether or not to provide an automatic printing start instruction of the document file.

3. The portable terminal apparatus according to claim 2, wherein the processor is configured to:
in a case where the automatic printing start instruction is designated, provide an instruction to automatically start printing the document file in a case where the user has approached to the distance.

4. The portable terminal apparatus according to claim 1, wherein the processor is configured to:
notify the user that printing of the document file is automatically started.

5. The portable terminal apparatus according to claim 4, wherein the processor is configured to:
in a case where the user has changed setting content related to printing in response to the notification, control printing of the document file in accordance with the changed content.

6. The portable terminal apparatus according to claim 1, wherein the processor is configured to:
in a case where an automatic printing start instruction is not designated, make an inquiry to the user as to whether or not to start printing the document file in a case where the user has approached the image forming apparatus to the distance.

7. The portable terminal apparatus according to claim 1, wherein the processor is configured to:
acquire installation positional information of each image forming apparatus capable of printing the document file; and
predict an image forming apparatus installed closest to a current position of the user within a predetermined range in the movement direction, as the image forming apparatus to be used for printing the document file by the user.

8. A printing service system comprising:
at least one portable terminal apparatus according to claim 1;
an image forming apparatus including at least a processor and a user interface; and
a service server that includes a processor and provides a printing instruction to the image forming apparatus in accordance with a printing start instruction from the portable terminal apparatus,
wherein the processor included in the image forming apparatus is configured to:
restrict use of the image forming apparatus by another user other than a user carrying the portable terminal apparatus, from a start to a finish of printing in accordance with the printing instruction from the service server.

9. The printing service system according to claim 8, wherein the processor included in the image forming apparatus is configured to:
restrict an operation of the user interface from the start to the finish of printing in accordance with the printing instruction from the service server.

10. The printing service system according to claim 8, wherein the processor included in the image forming apparatus is configured to:
permit use of a function that does not use a printing function, among a plurality of implemented functions.

11. The printing service system according to claim 8,
wherein the image forming apparatus further includes
an imager that images a user operating the image forming apparatus,
an output tray to which a printed matter is output, and
a sensor that detects an operation of acquiring the printed matter from the output tray, and
the processor included in the image forming apparatus is configured to:
in a case where the operation of acquiring the printed matter from the output tray by the other user is detected, output an alert message to the user interface.

12. The printing service system according to claim 11, wherein the processor included in the image forming apparatus is configured to:
in a case where the operation of acquiring the printed matter by the user carrying the portable terminal apparatus is detected, release the restriction on the use of the image forming apparatus.

13. The printing service system according to claim 8,
wherein the processor included in the portable terminal apparatus is configured to:
register a user capable of printing the document file in the service server in accordance with an instruction from the user, and
the processor included in the service server is configured to:
provide the printing instruction of the document file to the image forming apparatus in accordance with the printing start instruction from the portable terminal apparatus carried by the user capable of printing the document file.

14. A non-transitory computer readable medium storing a program causing a computer to implement:
a function of estimating a movement direction of a user carrying a portable terminal apparatus from a transition of a current position;
a function of, from among image forming apparatuses capable of printing a document file to be printed, predicting an image forming apparatus to be used for printing the document file by the user, by referring to the movement direction of the user; and
a function of providing a printing start instruction of the document file from the image forming apparatus in a case where the user has approached the image forming apparatus to a distance in which printing is estimated to be finished at a point when the user arrives at an installation position of the image forming apparatus.

15. A method comprising:
estimating a movement direction of a user carrying a portable terminal apparatus from a transition of a current position;
predicting, from among image forming apparatuses capable of printing a document file to be printed, an image forming apparatus to be used for printing the document file by the user, by referring to the movement direction of the user; and
providing a printing start instruction of the document file from the image forming apparatus in a case where the user has approached the image forming apparatus to a distance in which printing is estimated to be finished at a point when the user arrives at an installation position of the image forming apparatus.
